(19) United States
(12) Patent Application Publication
(10) Pub. No.: US 2015/0132043 A1
(43) Pub. Date: May 14, 2015

(54) WRITING INSTRUMENT

(71) Applicants: Hunter Scarborough, Calabasas, CA (US); Dane Scarborough, Van Nuys, CA (US)

(72) Inventors: Hunter Scarborough, Calabasas, CA (US); Dane Scarborough, Van Nuys, CA (US)

(21) Appl. No.: 14/401,441

(22) PCT Filed: May 15, 2013
(86) PCT No.: PCT/US13/41232

§ 371 Date: Nov. 14, 2014

Related U.S. Application Data
(60) Provisional application No. 61/647,185, filed on May 15, 2012.

(51) Int. Cl. B43K 7/10; B43K 21/02

(52) U.S. Cl. CPC B43K 7/10; B43K 21/02
USPC 401/143

(57) ABSTRACT

An improved writing instrument for applying a marking material to a surface through use of at least one ball.

The following description and the referenced drawings provide illustrative examples of that which the inventor regards as his invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc,” “for instance,” “in example,” “for example,” and “or” and grammatically related terms indicates non-exclusive alternatives without limitation, unless the context clearly dictates otherwise. The use of “including” and grammatically related terms means “including, but not limited to,” unless the context clearly dictates otherwise. The use of the articles “a,” “an” and “the” are meant to be interpreted as referring to the singular as well as the plural, unless the context clearly dictates otherwise. Thus, for example, reference to “a ball” includes two or more such balls, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment.

The use of “marking material” means any material, substance, compound, and/or element, used to mark a surface, unless the context clearly dictates otherwise. Examples of marking materials may include, but are not limited to, solid pigment cores, baked ceramic rods of clay bonded graphite (aka pencil lead), colored pencil lead, paint, chalk, dye, graphite, lead, and/or iron.

The use of “advancing mechanism” means a mechanism for advancing or compressing a marking material actuator or component thereof resulting in the advancement of the marking material, unless the context clearly dictates otherwise. Advancing mechanisms include, but are not limited to: screw-based pencils mechanisms in which twisting a screw moves a slider down the barrel of the pencil which advances the graphite; screw-based pencils mechanisms in which the graphite is advanced by direct friction with the screw; ratchet-based pencil mechanisms that are a variant of the clutch pencil in which the graphite is held in place by two or three small jaws inside a ring at the tip, wherein the jaws are controlled by a button on the end or on the side of the pencil, and when the button is pushed, the jaws move forward and separate, allowing the graphite to advance, wherein when the button is released and the jaws retract, the “graphite retainer” (a small rubber device inside the tip) keeps the graphite in place; spring loaded advancing mechanisms; graphite advancing mechanisms; ratchet-based pencil mechanisms in which shaking the pencil back and forth causes a weight inside the pencil to operate a mechanism in the cap, wherein a button may be present, or the lead may be advanced automatically, for instance by a ratchet but only prevented from going back into the pencil, just held from falling by a small amount of friction, wherein the nib is a spring-loaded collar that, when depressed, as the lead is worn away, pulls out more when pressure is released; a mechanical engine mechanisms that twist the pencil lead X degrees counter clockwise every time the lead is pressed on to the paper to keep the lead less broad than the common propelling mechanical pencils; screw-based pencil mechanisms in which the lead is advanced by direct friction with the screw; and twist-based pencil mechanisms in which the lead advances upon twisting the head of the pencil, which may require a locking mechanism one-way to allow the lead to be pushed back into the pencil to protect it when not in use.

Disclosed herein is an improved writing instrument for applying a marking material to a surface through use of at least one ball.

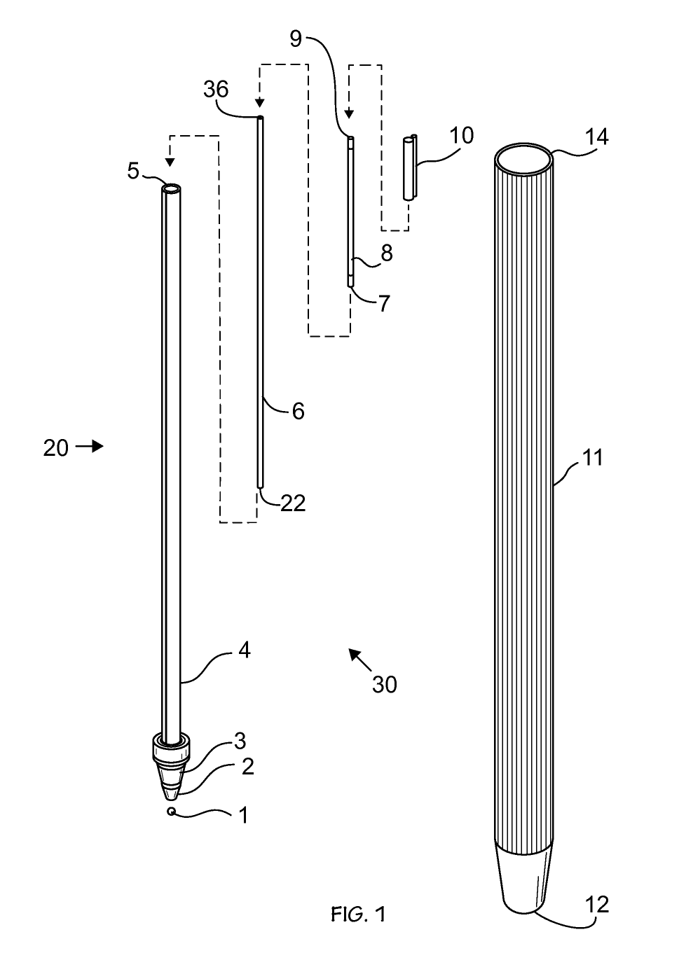

Referring initially to FIGS. 1 through 6, illustrated is a first embodiment of a writing instrument 100, a mechanical ballpoint pencil. The writing instrument 100 comprising an elongate body 11, a marking material actuator 30, and a marking material applicator 24.

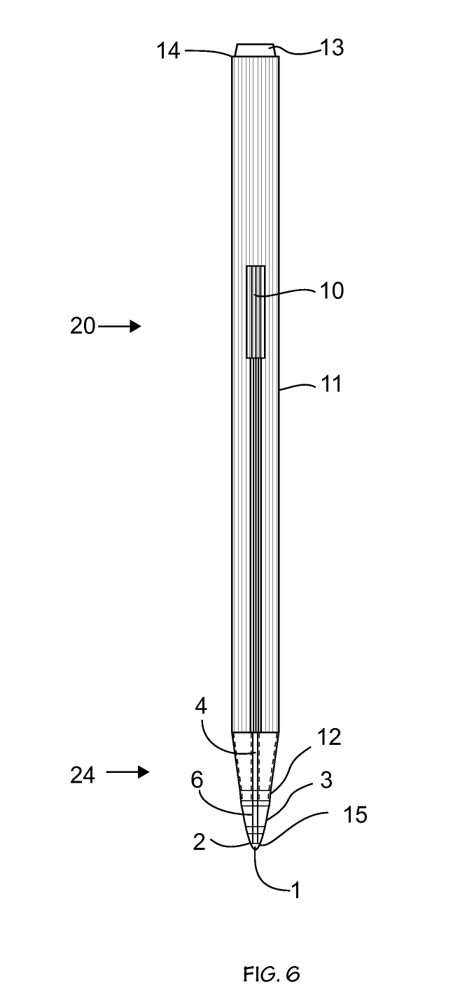

The body 11 comprising a first end 12 and a second end 14. The first end 12 configured for attaching with the marking material applicator 24. The second end 14 configured in some embodiments for attaching with an eraser 13, for instance the embodiment illustrated in FIG. 6. In FIG. 6, the writing instrument 20 is illustrated as assembled.

The marking material applicator 24 comprising a tip 3 through which the ball 1 extends. The tip 3 defining a socket 2 into which the ball 1 is received. The socket 2 comprising a retainer portion 15 having a rim 16 with a smaller diameter than the diameter of the ball 1, thereby retaining the ball 1 within the socket 2. The ball 1 being rotatable within the socket 2.

The ball 1 comprising a spherically shaped ball. In some embodiments, the ball can be smooth. In other embodiments, the ball can have a rough, textured outer surface.

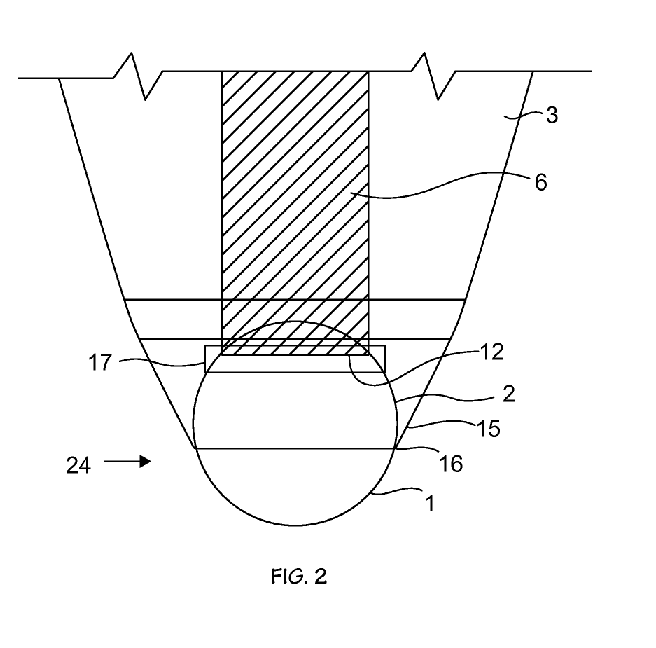

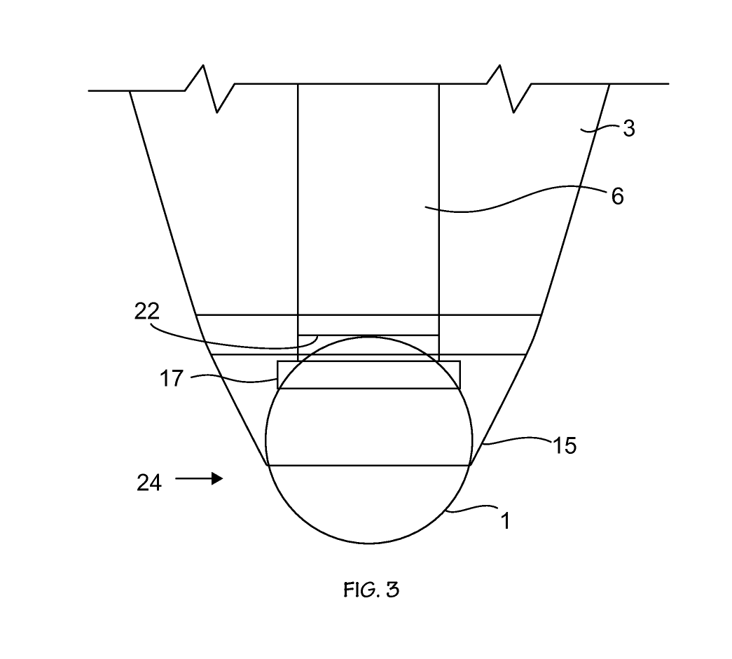

The marking material 6 extends from the marking material actuator 30 and contacts the ball 1 of the marking material applicator 24, as illustrated in FIGS. 2 and 3. FIG. 3 illustrates the marking material 6 having a face 22 which is configured for contacting against, and being abraded by, the outer surface of the ball 1. In some embodiments, as abrasion proceeds, the face 22 of the marking material 6 wears into a concave shape (as illustrated in FIG. 2). The opposite end of the marking material 6 comprising a butt 36 (illustrated in FIG. 3).

As illustrated in FIG. 2, the socket 2 defines a cavity 17 into which loose marking material removed from marking material 6 by the abrasion of the ball 1 can collect. The rotation of the ball through the cavity 17 resulting in further application of marking material to the outside surface of the ball 1. Inclusion of such a cavity 17 is optional, and may or may not be present in every embodiment.

The marking material actuator 30 is configured for advancing the face 22 of the marking material 6 against the surface of the ball 1. The marking material coating the ball can be applied to a surface to be marked by rolling the ball along the surface. The marking material actuator 30 further comprising an advancing mechanism for advancing or compressing the marking material actuator 30.

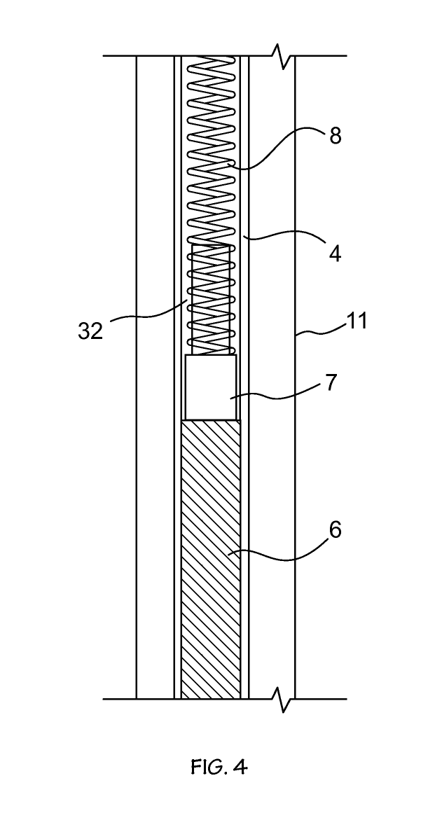

In FIG. 1, the marking material actuator 30 comprises an elongated protector 4, a constant force spring assembly 34, and an advancing mechanism. The elongated protector 4 connects to, and extends from, the marking material applicator 24. In the embodiment illustrated in FIGS. 1 through 6, the elongated protector 4 comprises an inner passageway 32 defined therethrough. The interior passageway 32 sized for receiving the marking material 6 therein, as illustrated in FIG. 4. The interior passageway 32 also configured for receiving a portion of the constant force spring assembly 34 therein, the constant force spring assembly 34 for advancing the marking material 6 against the ball 1.

In the embodiment illustrated in FIGS. 1 through 6, the constant force spring assembly 34 comprises a spring 8 and a manipulator 10. It is preferred that the spring 8 comprise a lower seat 7 for contacting the butt 36 of the marking material 6, and an upper seat 9 for contacting the manipulator 10.

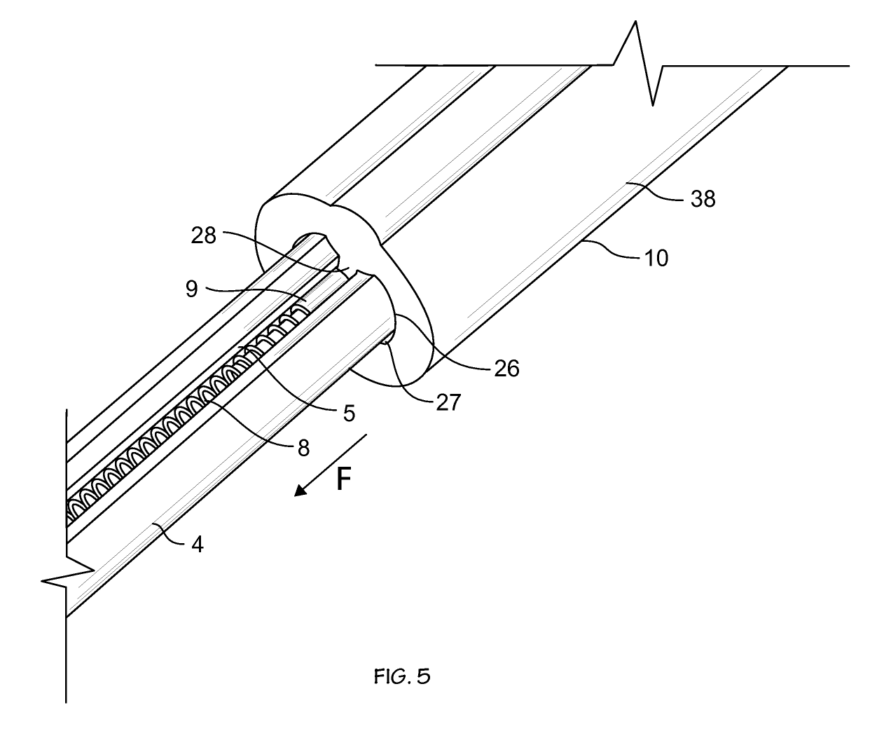

The elongated protector 4 further comprising an elongated slot 5, illustrated in FIGS. 1 and 5. In the illustrated embodiment of these figures, the slot 5 extends the entire length of the elongated protector 4. In other embodiments, such a slot may be absent, such a slot may be interrupted, a plurality of slots may be present, and/or the slot may extend along only part of the length of the elongated protector.

Referring now to FIG. 5, the manipulator 10 is illustrated as an elongated body 38 comprising an internal passageway defined therethrough, the internal passageway 27 extending from a first opening 26 to a second opening (not illustrated). The internal passageway 27 shaped for receiving the protector 4 therethrough, so that the manipulator 10 is slidingly engageable with the protector 4. The internal passageway 27 preferably comprises at least one guide flange 28 configured for receipt into the slot 5. The guide flange 28 for contacting the constant force spring assembly 34, preferably at the upper seat 9, so that movement of the elongated body 38 along the protector 4 in a first direction (F) results in the compression of the constant force spring assembly 34.

The marking material actuator 30 (and the manipulator 10) can be advanced in the first direction (F) through use of the advancing mechanism.

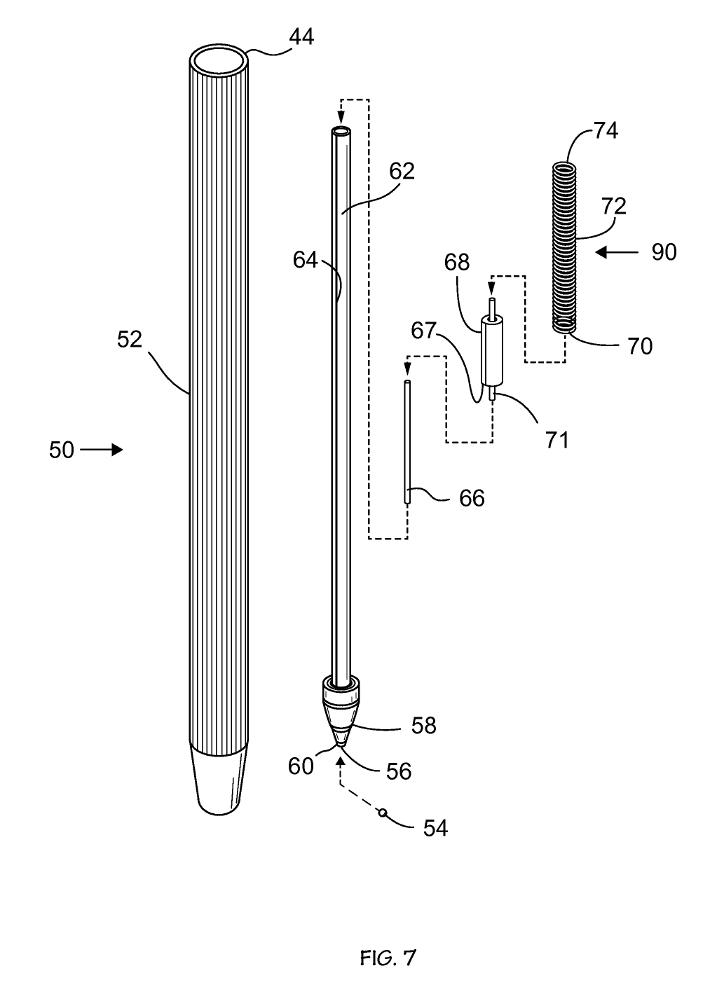

FIGS. 7 and 8 illustrate a second embodiment of a writing instrument 50, a mechanical ballpoint pencil. The writing instrument 50 comprising a body 52, a marking material actuator 90, and a marking material applicator 80.

The body 52 comprising a first end 42 and a second end 44. The first end 42 configured for attaching with the marking material applicator 80. The second end 44 configured in some embodiments for attaching with an eraser (not illustrated).

The marking material applicator 80 comprising a tip 58 through which a ball 54 extends. The tip 58 defining a socket 56 into which the ball 54 is received. The socket 56 comprising a retainer portion 60 having a rim with a smaller diameter than the diameter of the ball 54, thereby retaining the ball 54 within the socket 56. The ball 54 being rotatable within the socket 56.

The ball 54 comprising a spherically shaped ball. In some embodiments, the ball can be smooth. In other embodiments, the ball can have a rough, textured outer surface.

A rod of marking material 66 extends from the marking material actuator 90 and contacts the ball 54 of the marking material applicator 80, as illustrated in FIG. 8. The marking material 66 having a face which is configured for contacting against, and being abraded by, the outer surface of the ball 54. The marking material coating the ball can be applied to a surface to be marked by rolling the ball along the surface. The opposite end of the marking material 66 comprising a butt end.

The marking material actuator 90 is configured for advancing the face of the marking material 66 against the surface of the ball 54 through use of an advancing mechanism.

The marking material actuator 90 comprises an elongated protector 62, a constant force spring assembly 84, and an advancing mechanism. The elongated protector 62 which connects to, and extends from, the marking material applicator 80. In the embodiment illustrated in FIGS. 7 and 8, the elongated protector 62 comprises an inner passageway defined therethrough. The interior passageway sized for receiving the marking material 66 therein, as illustrated in FIG. 8.

The interior passageway, like the embodiment of FIGS. 1 through 6, is configured for receiving a portion of a constant force spring assembly 84 therein. The constant force spring assembly 84 for advancing the marking material 66 against the ball 54. The constant force spring assembly 84 comprises a spring 72 and a manipulator 10. It is preferred that the spring 72 comprise a lower seat 70 for contacting the butt end 69 of the manipulator 68, and an upper seat 74.

The elongated protector 62 further comprising an elongated slot 64. In the illustrated embodiment of these figures, the slot 64 extends the entire length of the elongated protector 62. In other embodiments, such a slot may be absent, such a slot may be interrupted, a plurality of slots may be present, and/or the slot may extend along only part of the length of the elongated protector.

The manipulator 68 is illustrated as an elongated body comprising an internal passageway defined therethrough, the internal passageway extending from a first opening to a second opening. The internal passageway shaped for receiving the protector 62 therethrough, so that the manipulator 68 is slidingly engageable with the protector 62. The internal passageway preferably comprises at least one guide flange 71 configured for receipt into the slot 64. The guide flange 71 for contacting the butt end of the marking material 66, so that movement of the elongated body along the protector 62 in a first direction results in face end of the marking material 66 being held in contact with the ball 54. Referring now to FIG. 8, the spring 72 and lower seat 70 are configured for being slidably engaged with the protector 62, receiving the protector 62 inside the coils of the spring 72.

The marking material actuator 90 (and the manipulator 68) can be advanced in the first direction (F) through use of an advancing mechanism.

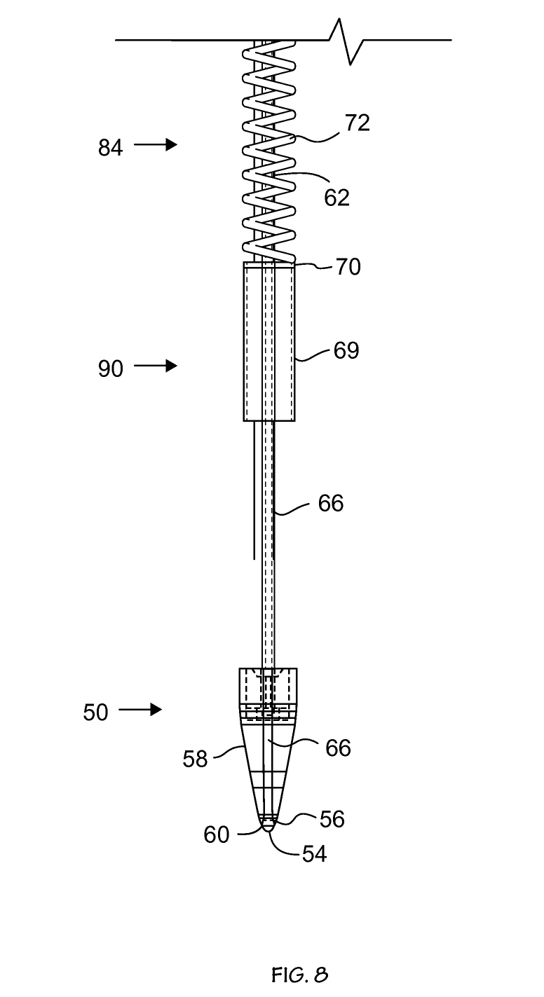

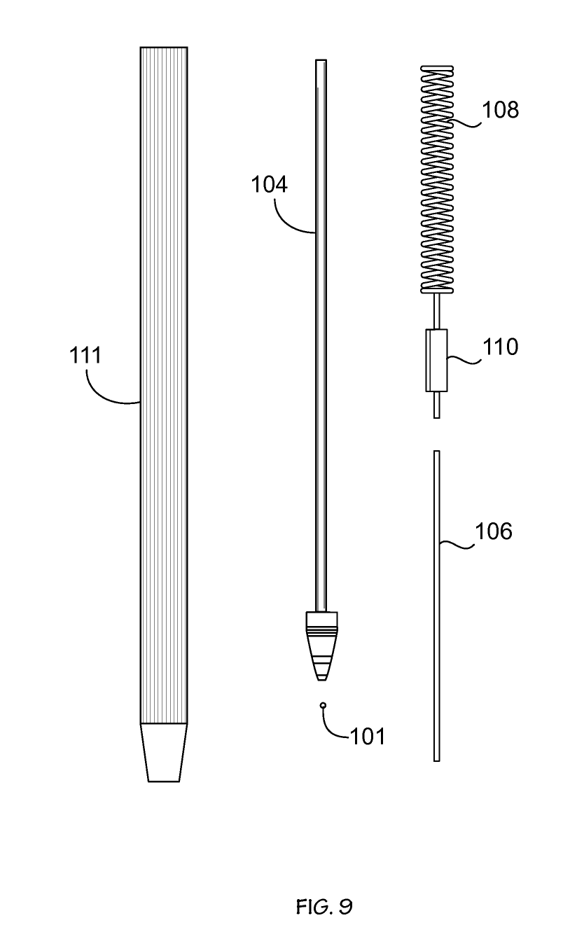

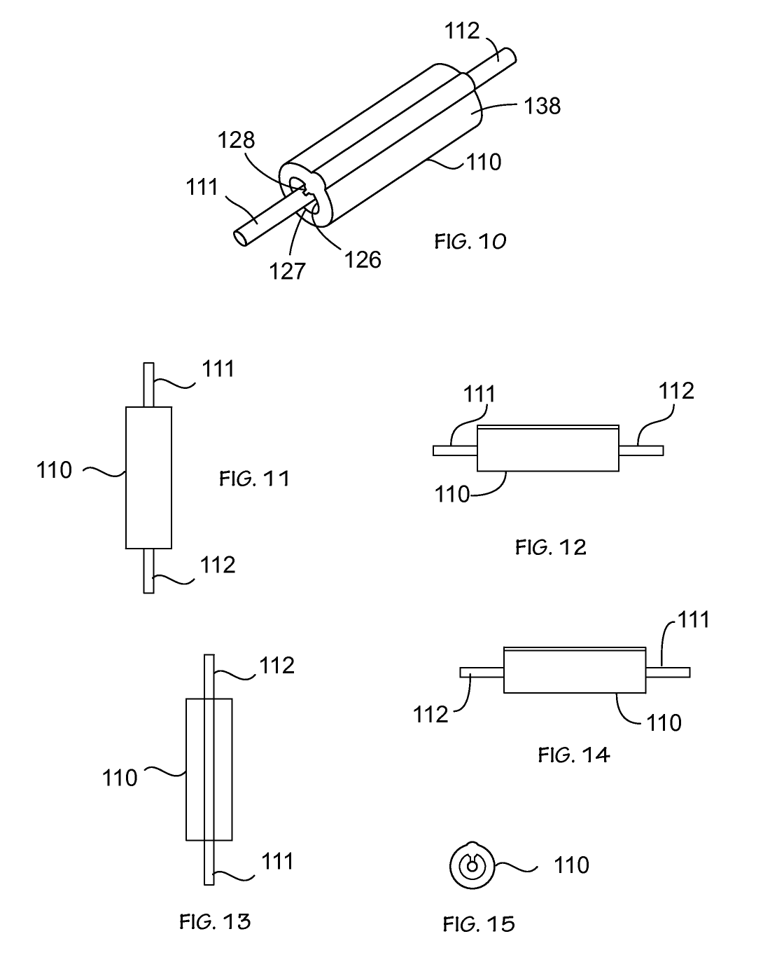

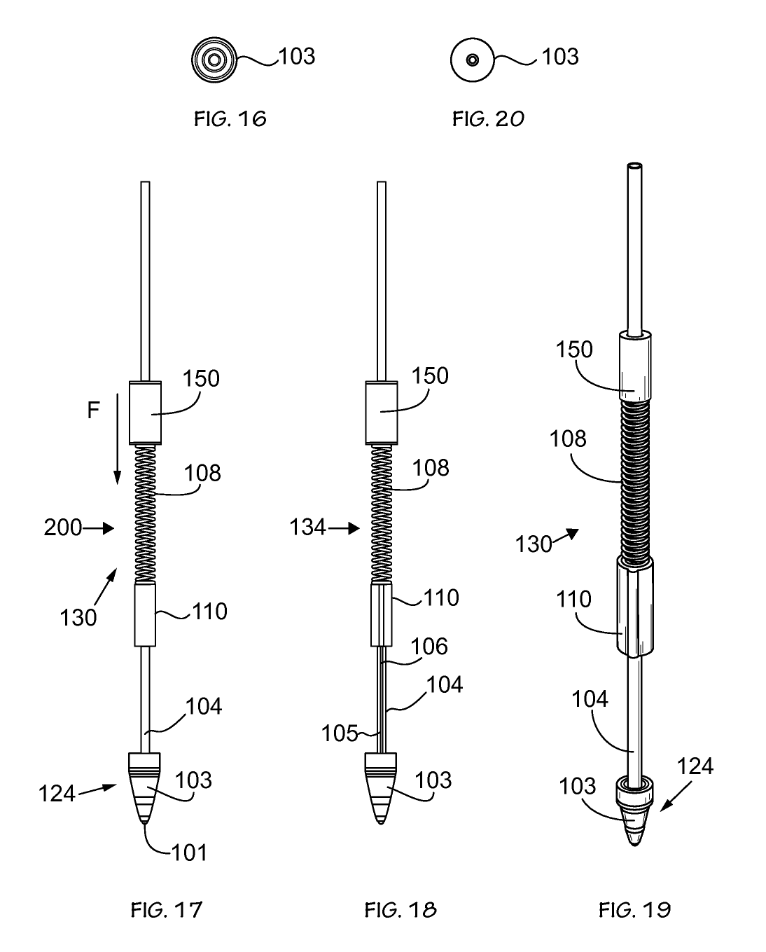

Referring now to FIGS. 10 through 20, illustrated is a third embodiment of a writing instrument 200, a mechanical ballpoint pencil. The third embodiment is similar to the first embodiment illustrated in FIGS. 1 through 6 and described above, except as detailed below.

The third embodiment of a writing instrument 200 is illustrated sans the elongate body. The elongate body 11 of FIG. 1 could be utilized with this embodiment. The writing instrument 200 comprising a marking material actuator 130, and a marking material applicator 124.

The marking material applicator 124 comprising a tip 103 through which the ball 101 extends. The tip 103 defining a socket into which the ball 101 is received. The socket comprising a retainer portion having a rim with a smaller diameter than the diameter of the ball 101, thereby retaining the ball 101 within the socket. The ball 101 being rotatable within the socket. The ball 101 comprising a spherically shaped ball. In some embodiments, the ball can be smooth. In other embodiments, the ball can have a rough, textured outer surface.

The marking material 106 extends from the marking material actuator 130 and contacts the ball 101 of the marking material applicator 124. The marking material actuator 130 is configured for advancing the face of the marking material 106 against the surface of the ball 101. The marking material coating the ball can be applied to a surface to be marked by rolling the ball along the surface. The marking material actuator 130 further comprising an advancing mechanism 150 for advancing or compressing the marking material actuator 130.

The marking material actuator 130 comprises an elongated protector 104, a constant force spring assembly 134, and an advancing mechanism 150. The elongated protector 104 connects to, and extends from, the marking material applicator 124. The elongated protector 104 comprises an inner passageway defined therethrough. The interior passageway sized for receiving the marking material 106 therein. The interior passageway 132 also configured for receiving a portion of the constant force spring assembly 134 therein, the constant force spring assembly 134 for advancing the marking material 106 against the ball 101.

The constant force spring assembly 134 comprises a spring 108 and a manipulator 110. The elongated protector 104 further comprising an elongated slot 105. The manipulator 110 is illustrated as an elongated body 138 comprising an internal passageway defined therethrough, the internal passageway 127 extending from a first opening 126 to a second opening (not illustrated). The internal passageway 127 shaped for receiving the protector 104 therethrough, so that the manipulator 110 is slidingly engageable with the protector 104. The internal passageway 127 preferably comprises at least one guide flange 128 configured for receipt into the slot 105. Connecting to the guide flange 128 is first extension 111 for contacting the butt of the marking material 106 and a second extension 112. The first extension 111 and second extension 112 are configured for transiting the internal passage of the protector 104.

The marking material actuator 130, and the manipulator 110 can be advanced in the first direction (F) through use of the advancing mechanism 150. In this embodiment, the advancing mechanism 150 comprises a weighted ratchet-based mechanisms in which shaking the writing instrument back and forth causes the weighted portion to ratchet in the first direction (F), compressing the spring.

In another embodiment, the writing instrument is a mechanical ballpoint pencil. The writing instrument comprising a marking material actuator, and a marking material applicator. The marking material applicator comprising a tip through which a ball extends. The tip defining a socket into which the ball is received. The socket comprising a retainer portion having a rim with a smaller diameter than the diameter of the ball, thereby retaining the ball within the socket. The ball being rotatable within the socket. Marking material extends from the marking material actuator and contacts the ball of the marking material applicator. The marking material actuator is configured for advancing the face of the marking material against the surface of the ball, where the marking material coating the ball can be applied to a surface to be marked by rolling the ball along the surface.

In another embodiment, the writing instrument is a mechanical ballpoint pencil. The mechanical ballpoint pencil has a generally cylindrical-shaped main body, and a means for advancing and or compressing an interior spring, which in turn contacts a seat for positioning a spring, a spring, a second seat for positioning a spring and engaging a solid substance marking material such as graphite. When the spring, is compressed, it advances a solid substance marking material such as graphite, through a cylindrical-shaped tube that in a preferred embodiment, would have a slot running a portion and or the length of it, until the solid substance marking material such as graphite, comes in contact with a rotatably engagable spherical ball, which is captured in a socket, and held in a rotatably engagable condition by a retainer portion. Once engaged, the spring would keep the solid substance marking material such as graphite in constant and controlled contact with the rotatably engagable spherical ball. When the portion of the rotatably engagable spherical ball, which is exposed, contacts a surface to be written on, the rotatably engagable spherical ball, rotates and transfers the solid substance marking material such as graphite, to the surface to be written on. In a preferred embodiment, the spherical ball, would be textured to various degrees allowing for options of more material or less material to be transferred as desired. Furthermore, as compression of the spring, is increased or decreased, the amount of solid substance marking material such as graphite, that is transferred via the rotatably engagable spherical ball would increase or decrease accordingly, giving greater control of the mark being made on the surface being written on.

In another embodiment the writing instrument comprises a mechanical ballpoint pencil. The ballpoint pencil comprising a tubular body having a bottom cap and a top cap. The ballpoint pencil comprising a tip element which is positioned inside, and protruding from, the bottom cap. The ballpoint pencil comprises a clamping mechanism above the tip element with a spring there-between. The ballpoint pencil comprises a sliding mechanism above the clamping mechanism. A single lead is stored in the sliding mechanism and is held by the clamping mechanism. When the lead outside the tip element is used up and the tip element is pressed, the spring is compressed and a segment of the lead is advanced into the tip element. When the tip element is released, the tip element is pushed downward by the spring and the segment of the lead is brought along with the tip element. By repeating the process a number of times, the lead would be extended out of the tip element.

In another embodiment, the writing instrument comprises a tubular member with a hollow interior place-able in communication with a marking material, the marking material held in controlled compression contact with a spherical ball. The spherical ball is rotatably engaged in a socket formed at one end of the member having a seat and a cylindrical wall extending from the seat and a rim structure disposed at the end of the cylindrical wall opposite the seat, a spherical ball disposed in the socket, rotatably engagable with the seat and captured by the rim structure.

In another embodiment, the writing instrument comprises a tubular member with a hollow interior place-able in communication with a marking material, the marking material held in controlled compression contact with a spherical ball. The spherical ball is rotatably engaged in a socket formed at one end of the member having a seat and a cylindrical wall extending from the seat and a rim structure disposed at the end of the cylindrical wall opposite the seat, a spherical ball disposed in the socket, rotatably engagable with the seat and captured by the rim structure, the diameter of the ball being at least three percent smaller than the diameter of the seat at the intersection of the seat and the cylindrical wall.

In another embodiment, the writing instrument comprises an elongate body, a marking material actuator, marking material, and a marking material applicator. Preferably, the elongate body comprising a first end and a second end, the first end configured for attaching to with the marking material applicator. Preferably, the marking material applicator comprising a tip through which a ball extends, the ball having a diameter, the tip defining a socket into which the ball is received, the socket comprising a retainer portion having a rim with a smaller diameter than the diameter of the ball, thereby retaining the ball within the socket, the ball being rotatable within the socket. Preferably, the marking material actuator comprising an elongated protector, a constant force spring assembly for advancing the marking material against the ball, and an advancing mechanism for compressing the constant force spring. Preferably, the marking material is configured for extending from the marking material actuator and contacting the ball of the marking material applicator, wherein the marking material is applied to an outer surface of the ball. Preferably, the elongated protector connects to the marking material applicator. Preferably, the elongated protector comprises an inner passageway defined therethrough. Preferably, the interior passageway is sized for receiving the marking material therein. Preferably, the interior passageway is configured for receiving a portion of the constant force spring assembly therein. Preferably, the constant force spring assembly comprises a spring and a manipulator. Preferably, the manipulator comprises an internal passageway defined therethrough, the internal passageway extending from a first opening to a second opening. Preferably, the internal passageway is shaped for receiving the protector therethrough, whereby the manipulator is slidingly engageable with the protector. Preferably, the elongated protector further comprises an elongated slot. Preferably, the internal passageway preferably comprises at least one guide flange configured for receipt into the slot. Preferably, the guide flange is configured for contacting the constant force spring assembly. Movement of the elongated body along the protector in a first direction results in the compression of the constant force spring assembly. Preferably, the marking material actuator can be advanced in a first direction through use of the advancing mechanism. Preferably, the ball has a textured outer surface. Preferably, the socket defines a cavity into which loose marking material removed from marking material by the abrasion of the ball can collect. Preferably, rotation of the ball through the cavity results in further application of marking material to the outside surface of the ball.

It is noted that all structure and features of the various described and illustrated embodiments can be combined in any suitable configuration for inclusion in a writing instrument according to a particular embodiment. For example, a writing instrument according a particular embodiment can include neither, one, or both of a spring located inside the protector, and the spring located outside the protector described above.

Any suitable materials can be used to form the various components of the writing instrument, and a skilled artisan will be able to select appropriate materials for a writing instrument according to a particular embodiment based on various considerations, including the environment within which the writing instrument is intended to be used. The inventor has determined that conventional organic, polymeric and metal materials are suitable for use in the various components of the writing instrument. Materials hereinafter discovered and/or developed that are determined to be suitable for use in writing instruments would also be considered suitable for use in a writing instrument according to a particular embodiment.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A writing instrument comprising:
an elongate body, a marking material actuator, marking material, and a marking material applicator;
said elongate body comprising a first end and a second end, said first end configured for attaching to with said marking material applicator;
said marking material applicator comprising a tip through which a ball extends, said ball having a diameter, said tip defining a socket into which said ball is received, said socket comprising a retainer portion having a rim with a smaller diameter than the diameter of said ball, thereby retaining said ball within the socket, said ball being rotatable within said socket; and
said marking material actuator comprising an elongated protector, a constant force spring assembly for advancing said marking material against said ball, and an advancing mechanism for compressing said constant force spring;
wherein said marking material is configured for extending from said marking material actuator and contacting the ball of the marking material applicator, wherein said marking material is applied to an outer surface of said ball.

2. The writing instrument of claim 1, wherein said elongated protector connects to said marking material applicator.

3. The writing instrument of claim 1, wherein said elongated protector comprises an interior passageway defined therethrough.

4. The writing instrument of claim 3, wherein said interior passageway is sized for receiving said marking material therein.

5. The writing instrument of claim 4, wherein said interior passageway is configured for receiving a portion of the constant force spring assembly therein.

6. The writing instrument of claim 1, wherein said constant force spring assembly comprises a spring and a manipulator.

7. The writing instrument of claim 6, wherein said manipulator comprises an internal passageway defined therethrough, said internal passageway extending from a first opening to a second opening.

8. The writing instrument of claim 7, wherein said internal passageway is shaped for receiving the protector therethrough, whereby said manipulator is slidingly engageable with said protector.

9. The writing instrument of claim 1, wherein said elongated protector further comprises an elongated slot.

10. The writing instrument of claim 9, wherein said elongated protector comprises an interior passageway defined therethrough.

11. The writing instrument of claim 10, wherein said interior passageway preferably comprises at least one guide flange configured for receipt into the elongated slot.

12. The writing instrument of claim 11, wherein said guide flange is configured for contacting the constant force spring assembly.

13. The writing instrument of claim 12, wherein movement of the elongated body along the protector in a first direction results in the compression of the constant force spring assembly.

14. The writing instrument of claim 1, wherein the marking material actuator can be advanced in a first direction through use of the advancing mechanism.

15. The writing instrument of claim 1, wherein said ball has a textured outer surface.

16. The writing instrument of claim 1, wherein said socket defines a cavity into which loose marking material removed from marking material by the abrasion of the ball can collect.

17. The writing instrument of claim 16, wherein rotation of the ball through said cavity results in further application of marking material to the outside surface of said ball.
